(19) United States
(12) Patent Application Publication
(10) Pub. No.: US 2015/0098717 A1
(43) Pub. Date: Apr. 9, 2015

(54) ELECTROPHOTOGRAPHIC IMAGE FORMING APPARATUS

(71) Applicant: Samsung Electronics Co., Ltd., Suwon-si (KR)

(72) Inventors: Sung-min PARK, Gwacheon-si (KR); Dong-uk Kim, Suwon-si (KR); Ki-hyun Yoo, Suwon-si (KR)

(73) Assignee: Samsung Electronics Co., Ltd., Suwon-si (KR)

(21) Appl. No.: 14/244,304

(22) Filed: Apr. 3, 2014

(30) Foreign Application Priority Data
Oct. 4, 2013 (KR) 10-2013- 0118725

(51) Int. Cl. G03G 15/00; G03G 15/06; G03G 15/16; G03G 15/02

(52) U.S. Cl. CPC G03G 21/0047
USPC 399/46; 399/55; 399/71; 399/50; 399/66

(57) ABSTRACT

An electrophotographic image forming apparatus including a photoreceptor on which an electrostatic latent image is formed, a developing roller for forming a visual toner image by supplying toner onto the electrostatic latent image, a transfer unit for transferring the visual toner image onto a recording medium, and a cleaning member for removing residual toner remaining on the photoreceptor after the transfer of the visual toner image from the photoreceptor is described. The image forming apparatus operates in a printing mode, and a collecting mode in which the residual toner on the cleaning member is collected on the developing roller via the photoreceptor. A linear velocity of the developing roller in the collecting mode is faster than in the printing mode.

### CROSS-REFERENCE TO RELATED APPLICATIONS

This application claims the priority benefit of Korean Patent Application No. 10-2013-0118725, filed on Oct. 4, 2013, in the Korean Intellectual Property Office, the disclosure of which is incorporated herein in its entirety by reference.

### BACKGROUND

1. Field

One or more embodiments relate to an electrophotographic image forming apparatus capable of collecting toner, which remains on a photoreceptor, on a developing roller after transfer of an image.

2. Description of the Related Art

Electrophotographic image forming apparatuses print an image on a recording medium by forming an electrostatic latent image on a photoreceptor by scanning light modulated to correspond to image information to the photoreceptor, developing the electrostatic latent image to a visual toner image by supplying toner to the electrostatic latent image, and transferring and fixing the toner image onto the recording medium.

While the toner image is transferred from the photoreceptor to the recording medium, some toner is not transferred and remains on the photoreceptor. The remaining toner may be removed from the photoreceptor, and stored in an additional space or collected on a developing roller.

### SUMMARY

One or more embodiments include an electrophotographic image forming apparatus capable of efficiently collecting residual toner on a developing roller.

One or more embodiments include an electrophotographic image forming apparatus capable of shortening a time needed to collect residual toner on a developing roller.

According to one or more embodiments, there are provided an electrophotographic image forming apparatus includes a photoreceptor; a charger to which a first charge bias voltage is applied to charge the photoreceptor to a uniform potential; an exposure device to form an electrostatic latent image by applying light, which is modulated according to image information, to a charged photosensitive drum; a developing roller to form a visual toner image by supplying toner onto the electrostatic latent image; a transfer unit to which a first transfer bias voltage is applied to transfer the visual toner image onto a recording medium; and a cleaning member to which a first cleaning bias voltage is applied to separate residual toner, which remains on the photoreceptor after the transfer of the visual toner image, from the photoreceptor when printing is performed and store the residual toner, and to which a second cleaning bias voltage is applied to attach the residual toner to the photoreceptor when the toner is collected. A first developing bias voltage is applied to the developing roller to supply the toner onto the electrostatic latent image when printing is performed. A second developing bias voltage is applied to the developing roller to collect the residual toner attached to the photoreceptor on the developing roller when the toner is collected. When a ratio of a linear velocity of the developing roller to a linear velocity of the photoreceptor is a linear velocity ratio, the linear velocity ratio when the toner is collected is greater by about 25% or more than when printing is performed.

The first cleaning bias voltage may have the same polarity as the first transfer bias voltage, and have an absolute value that is greater than an absolute value of the first transfer bias voltage

A second transfer bias voltage having the same polarity as charge polarity of the residual toner may be applied to the transfer unit when the toner is collected.

A second charge bias voltage having the same polarity as the first charge bias voltage and an absolute value that is less than an absolute value of the first charge bias voltage may be applied to the charger, when the toner is collected. The second cleaning bias voltage may have the same polarity as the second charge bias voltage and an absolute value that is greater than an absolute value of the second charge bias voltage. The difference between surface potentials of the developing roller and the photoreceptor when printing is performed may be the same as when the toner is collected. The difference between the first charge bias voltage and the first developing bias voltage may be the same as the difference between the second charge bias voltage and the second developing bias voltage.

The second developing bias voltage may be 0 V when the toner is collected.

The electrophotographic image forming apparatus may further include an auxiliary charge member which is disposed between the cleaning member and the charger and to which an auxiliary charge bias voltage is applied to charge reverse-polarity toner attached to the photoreceptor into normal-polarity toner.

The auxiliary charge bias voltage when printing is performed may be the same as when the toner is collected. The auxiliary charge bias voltage may have an absolute value that is less than an absolute value of the first charge bias voltage.

A linear velocity of the photoreceptor when printing is performed may be the same as when the toner is collected.

According to one or more embodiments, an electrophotographic image forming apparatus includes a photoreceptor on which an electrostatic latent image is formed; a developing roller to form a visual toner image by supplying toner onto the electrostatic latent image; a transfer unit transfer the visual toner image onto a recording medium; and a cleaning member to remove residual toner, which remains on the photoreceptor after the transfer of the visual toner image, from the photoreceptor. The image forming apparatus operates in a printing mode, and a collecting mode in which the residual toner on the cleaning member is collected on the developing roller via the photoreceptor, and a linear velocity of the developing roller in the collecting mode is faster than in the printing mode.

A linear velocity of the photoreceptor in the collecting mode may be the same as in the printing mode.

When a ratio of the linear velocity of the developing roller to the linear velocity of the photoreceptor is a linear velocity ratio, the linear velocity ratio in the collecting mode may be greater by about 25% or more than in the printing mode.

The electrophotographic image forming apparatus may further include a charger for charging the photoreceptor; and an exposure device to form the electrostatic latent image by applying light, which is modulated according to image information, to a charged photosensitive drum. In the printing mode, a first cleaning bias voltage may be applied to the cleaning member so as to separate the residual toner, which remains on the photoreceptor after the transfer of the visual toner image, from the photoreceptor and store the residual toner, and a first developing bias voltage may be applied to the developing roller to supply the toner onto the electrostatic latent image. In the collecting mode, a second cleaning bias voltage may be applied to the cleaning member to attach the residual toner thereon to the photoreceptor, a second developing bias voltage may be applied to the developing roller to collect the residual toner attached to the photoreceptor on the developing roller, and a second charge bias voltage having an absolute value that is less than an absolute value of the first charge bias voltage in the printing mode may be applied to the charger.

A first transfer bias voltage having polarity opposite to charge polarity of the toner may be applied to the transfer unit in the printing mode. A second transfer bias voltage having the same polarity as the charge polarity of the toner may be applied to the transfer unit in the collecting mode. The first cleaning bias voltage may have the same polarity as the first transfer bias voltage and an absolute value that is greater than the first transfer bias voltage.

The second cleaning bias voltage may have the same polarity as the second charge bias voltage and an absolute value that is greater than an absolute value of the second charge bias voltage.

The electrophotographic image forming apparatus may further include an auxiliary charge member which is disposed between the cleaning member and the charger, and to which an auxiliary charge bias voltage is applied to charge reverse-polarity toner attached to the photoreceptor to normal polarity. The auxiliary charge bias voltage may have an absolute value that is less than an absolute value of the first charge bias voltage.

The second developing bias voltage may be 0 V in the collecting mode.

### BRIEF DESCRIPTION OF THE DRAWINGS

These and/or other aspects will become apparent and more readily appreciated from the following description of embodiments, taken in conjunction with the accompanying drawings in which:

FIG. 1 is a schematic diagram illustrating a structure of an electrophotographic image forming apparatus according to an embodiment;

FIG. 2 is a schematic diagram illustrating a process of performing developing and transfer operations according to an embodiment;

FIG. 3 is a schematic diagram illustrating a toner collecting process according to an embodiment; and

FIG. 4 is a timing chart of a toner collecting process according to an embodiment.

### DETAILED DESCRIPTION

Reference will now be made in detail to embodiments, examples of which are illustrated in the accompanying drawings, wherein like reference numerals refer to like elements throughout. In this regard, embodiments may have different forms and should not be construed as being limited to the descriptions set forth herein. Accordingly, embodiments are merely described below, by referring to the figures, to explain aspects of the present disclosure.

Hereinafter, electrophotographic image forming apparatuses according to various embodiments will be described with reference to the accompanying drawings.

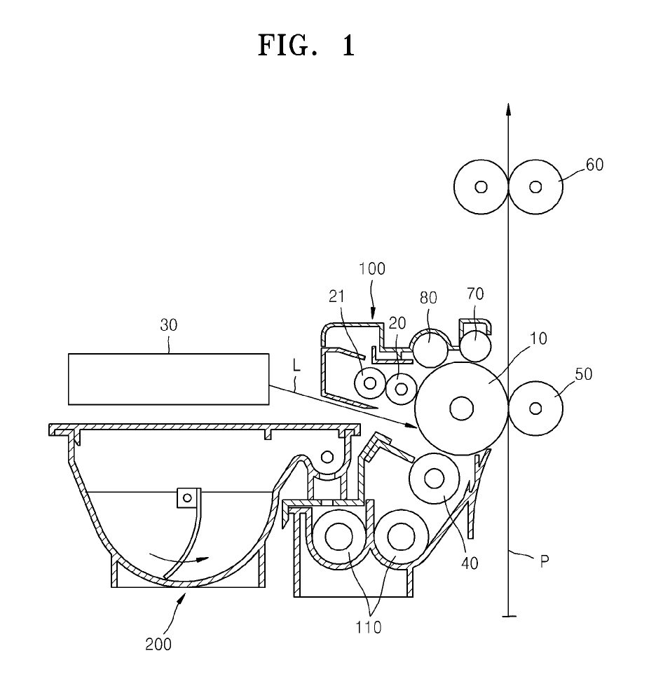

FIG. 1 is a schematic diagram illustrating a structure of an electrophotographic image forming apparatus according to an embodiment. According to embodiments, the image forming apparatus is a monochromatic image forming apparatus and the color of toner is, for example, black.

Referring to FIG. 1, a photosensitive drum 10 is an example of a photoreceptor on which an electrostatic latent image is formed, in which, for example, a cylindrical metal pipe. In the photosensitive drum 10, e.g., a cylindrical metal pipe, a photosensitive layer having optical conductivity is formed on an outer circumference of the cylindrical metal pipe. A photosensitive belt that makes a rotating motion and in which a photosensitive layer is formed on an external surface may be employed instead of the photosensitive drum 10.

A charge roller 20 is an example of a charger that charges a surface of the photosensitive drum 10 with uniform charge potentials. The charge roller 20 rotates in contact with the photosensitive drum 10. A bias voltage is applied to the charge roller 20 to charge the photosensitive drum 10. A corona charger (not shown) configured to cause a corona discharge to occur so as to charge a surface of the photosensitive drum 10 may be employed instead of the charge roller 20. Additionally, a charge roller cleaning member 21 may be used. The charge roller cleaning member 21 is configured to remove foreign substances adhered to the charge roller 20. For example, the charge roller cleaning member 21 may have a roller form that rotates in contact with the charge roller 20.

An exposure device 30 applies light corresponding to image information to a charged surface of the photosensitive drum 10 so as to form an electrostatic latent image. A laser scanning unit (LSU) that scans light radiated from a laser diode on the photosensitive drum 10 by deflecting the light in a main scanning direction using a polygon mirror may be employed as the exposure device 30, but embodiments are not limited thereto.

A developing agent is stored in a developing device (developing unit) 100. The developing device 100 includes a developing roller 40. The developing roller 40 forms a visual toner image on the photosensitive drum 10 by supplying toner contained in the developing agent onto the electrostatic latent image formed on the photosensitive drum 10.

A transfer roller 50 is an example of a transfer unit that transfers the toner image formed on the photosensitive drum 10 onto paper. The transfer roller 50 and the photosensitive drum 10 are disposed to face each other to form a transfer nip. A bias voltage is applied to the transfer roller 50 so as to transfer the toner image formed on the photosensitive drum 10 to a recording medium P. A corona transfer unit that uses a corona discharge may be employed instead of the transfer roller 50.

The toner image transferred to the recording medium P is attached to the recording medium P by an electrostatic force. A fusing device 60 fixes the toner image on the recording medium P by applying heat and pressure to the toner image.

Toner that is not transferred to the recording medium P and remains on the photosensitive drum 10 is removed by a cleaning member 70. The cleaning member 70 may be, for example, a rubber or sponge roller (cleaning roller) that rotates in contact with a surface of the photosensitive drum 10. The cleaning member 70 will be hereinafter referred to as the ‘cleaning roller 70’.

Additionally, an auxiliary charge member 80 may be further prepared. The auxiliary charge member 80 is configured to attract and temporarily store reverse-polarity toner among residual toner on the photosensitive drum 10, and charge the reverse-polarity toner again to normal polarity. The auxiliary charge member 80 may be, for example, a brush roller (auxiliary charge roller) that rotates in contact with a surface of the photosensitive drum 10. Hereinafter, the auxiliary charge member 80 will be hereinafter referred to as the ‘auxiliary charge roller 80’.

The developing unit 100 supplies the toner contained therein to the electrostatic latent image formed on the photosensitive drum 10 so as to develop the electrostatic latent image to a visual image. Toner is stored in the developing unit 100 when a one-component developing method is employed, and toner and a carrier are stored in the developing unit 100 when a two-component developing method is employed. A bias voltage is applied to the developing roller 40 so as to supply the toner stored in the developing unit 100 to the photosensitive drum 10.

The one-component developing method may be classified into a contact developing method in which the developing roller 40 and the photosensitive drum 10 rotate in contact with each other, and a non-contact developing method in which the developing roller 40 and the photosensitive drum 10 rotate while they are spaced by about several tens to several hundreds of microns.

When the two-component developing method is employed, the developing roller 40 is disposed apart by about several tens to several hundreds of microns from the photosensitive drum 10. Although not shown, the developing roller 40 may have a structure in which a magnetic roller is disposed in a hollow cylindrical sleeve. Toner is attached to surfaces of magnetic carriers. The magnetic carriers are delivered to a developing region in which the photosensitive drum 10 and the developing roller 40 face each other while the magnetic carriers are attached to a surface of the developing roller 40. When a bias voltage is applied between the developing roller 40 and the photosensitive drum 10, only the toner is supplied to the photosensitive drum 10 and thereby the electrostatic latent image formed on the photosensitive drum 10 is developed to a visual toner image. The developing unit 100 may include an agitator 110 configured to mix toner with carrier, agitate a mixture of the toner and the carrier, and transport the mixture to the developing roller 40. The agitator 110 may be, for example, an auger.

Toner may be stored in a toner cartridge 200. The toner is supplied from the toner cartridge 200 to the developing unit 100. When the toner stored in the toner cartridge 200 is completely consumed, the toner cartridge 200 may be replaced with a new toner cartridge 200 or may be filled with new toner. The toner cartridge 200 may be integrally formed with the developing unit 100.

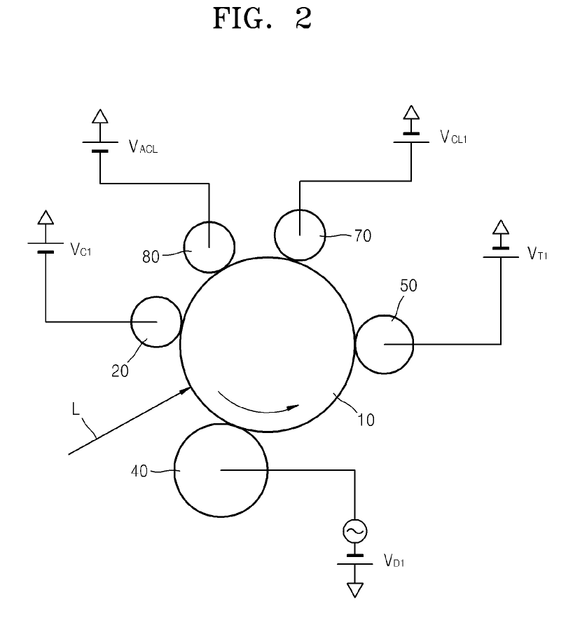

FIG. 2 is a schematic diagram illustrating a process of performing developing and transfer operations according to an embodiment. An example of an operation of an image forming apparatus in a print mode will now be described with reference to FIGS. 1 and 2. In the developing unit 100, toner may be charged with (−) or (+) polarity. In the current embodiment, a case in which toner is charged with (−) polarity will be described. Hereinafter, the toner charged with (−) polarity will be referred to as ‘normal-polarity toner’, and toner charged with polarity opposite to that of the normal-polarity toner, i.e., (+) polarity, will be referred to as ‘reverse-polarity toner’.

First, a first charge bias voltage V_{C1} having the same polarity as charge polarity of toner is applied to the charge roller 20. Thus, a surface of the photosensitive drum 10 may be charged with uniform electric potentials. For example, the first charge bias voltage V_{C1} may be about −1350 V, and a surface potential of the charged photosensitive drum 10 may be, for example, about −600 V.

The exposure device 30 applies light L modulated to correspond to image information to a surface of the photosensitive drum 10. In this case, an absolute value of an electric potential of a portion (exposed portion) of the surface of the photosensitive drum 10 exposed to the light L becomes less than that of an electric potential of a non-exposed portion of the photosensitive drum 10. An electrostatic latent image is formed on the photosensitive drum 10 due to the difference between the electric potentials of the exposed portion and non-exposed portion of the photosensitive drum 10.

The normal-polarity toner is delivered to the developing region in which the photosensitive drum 10 and the developing roller 40 face each other while the normal-polarity toner is attached to the surface of the developing roller 40. A first developing bias voltage V_{D1} having the same polarity as the charge polarity of the toner is applied to the developing roller 40. The first developing bias voltage V_{D1} is set between surface potentials of the exposed portion and non-exposed portion of the photosensitive drum 10. For example, the first developing bias voltage V_{D1} may be about −450 V. The first developing bias voltage V_{D1} may be a direct-current (DC) voltage or may have a form in which a DC voltage and an alternating-current (AC) voltage overlap. The first developing bias voltage V_{D1} causes a developing electric field to be formed between the photosensitive drum 10 and the developing roller 40 in a direction in which the normal-polarity toner is moved from the developing roller 40 to the photosensitive drum 10. The normal-polarity toner is attached to the exposed portion of the photosensitive drum 10 and causes the electrostatic latent image to be developed to a visual toner image. The normal-polarity toner is not attached to the non-exposed portion of the photosensitive drum 10 due to an electrostatic repulsive force.

A first transfer bias voltage Vₜ₁ having polarity opposite to that of the normal-polarity toner is applied to the transfer roller 50, and a transfer electric field is thus formed between the photosensitive drum 10 and the transfer roller 50 in a direction in which the normal-polarity toner is transferred from the photosensitive drum 10 to the recording medium P. The first transfer bias voltage V_{T1} may be, for example, about 500 V. The transfer electric field causes the toner image to be transferred to the recording medium P.

After the toner image is transferred, toner remaining on the photosensitive drum 10 is removed by the cleaning roller 70. A first cleaning bias voltage V_{CL1} having polarity opposite to that of the normal-polarity toner is applied to the cleaning roller 70. An absolute value of the first cleaning bias voltage V_{CL1} is set to be greater than that of the first transfer bias voltage V_{T1}. Thus, an electrostatic attraction sufficient to attract the toner that is not transferred to the recording medium P and that remains on the photosensitive drum 10 and separate the residual toner from the surface of the photosensitive drum 10 may be generated. The first cleaning bias voltage V_{CL1} may be, for example, about 750 V. The first cleaning bias voltage V_{CL1} causes the normal-polarity toner to be moved from the photosensitive drum 10 to the cleaning roller 70 and stored on the cleaning roller 70.

During the charging of the toner in the developing unit 100, reverse-polarity toner charged with polarity opposite to that of the normal-polarity toner and non-charged toner particles with an insufficient charging amount may be generated. Also, during the transfer of the toner image, the normal-polarity toner may be transformed into reverse-polarity toner or non-charged toner particles. The reverse-polarity toner has the same polarity as the first cleaning bias voltage V_{CL1} and is thus not transferred to the cleaning roller 70 and remains on the photosensitive drum 10 due to an electrostatic repulsive force. Also, the non-charged toner particles with an insufficient charging amount may not be transferred to the cleaning roller 70 and may remain on the photosensitive drum 10 due to an insufficient electrostatic attraction. An auxiliary charge bias voltage V_{ACL} having the same polarity as the normal-polarity toner is applied to the auxiliary charge roller 80. In this case, the reverse-polarity toner on the surface of the photosensitive drum 10 moves to the auxiliary charge roller 80 and is charged by the auxiliary charge bias voltage V_{ACL} to be transformed into normal-polarity toner. The resultant normal-polarity toner moves to the surface of the photosensitive drum 10. The non-charged toner particles on the photosensitive drum 10 are charged by the auxiliary charge bias voltage V_{ACL} to be transformed into normal-polarity toner. The resultant normal-polarity toner contacts the developing roller 40 again as the photosensitive drum 10 rotates, and is collected into the developing unit 100 by the first developing bias voltage Vd1.

The normal-polarity toner on the cleaning roller 70 is collected into the developing unit 100 via the photosensitive drum 10. When the normal-polarity toner is not sufficiently collected from the cleaning roller 70, residual toner is accumulated on the cleaning roller 70 and a background portion of a printed image may be polluted with the residual toner. Also, the capability of the cleaning roller 70 that removes residual toner may be lowered to cause occurrence of a ghost image error that an image of a previously printed image is left on a printed image. A toner collecting process may be performed before a print job is completed, when warm-up is performed to start a print job, and when a current number of printing sheets becomes equal to a set number of continuous printing sheets when a large amount of continuous printing is performed.

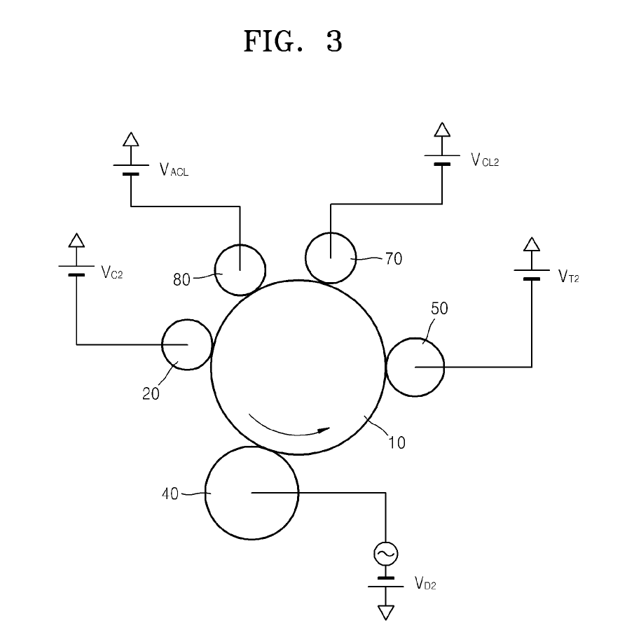

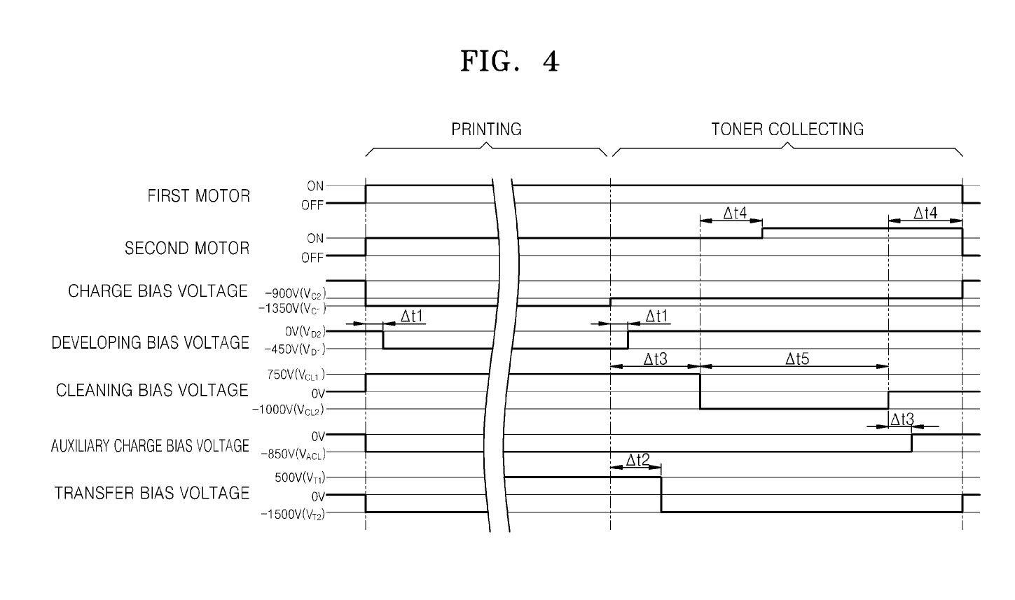

FIG. 3 is a schematic diagram illustrating a toner collecting process according to an embodiment. FIG. 4 is a timing chart of a toner collecting process according to an embodiment. An example of an operation of an image forming apparatus according to an embodiment in a toner collecting mode will now be described in detail with reference to FIGS. 3 and 4. A photosensitive drum 10, a charge roller 20, a cleaning roller 70, and an auxiliary charge roller 80 are driven by a first motor (not shown), and a developing roller 40 is driven by a second motor (not shown).

[Second Charge Bias Voltage V_{C2}]

The first and second motors continuously rotate even after a print job is completed, and a second charge bias voltage V_{C2}is applied to the charge roller 20 and a surface of the photosensitive drum 10 is charged to a predetermined potential when the collecting process starts. During the toner collecting process, an entire surface of the photosensitive drum 10 may preferably function as an effective portion to which normal-polarity toner separated from the cleaning roller 70 is attached. Thus, an absolute value of a surface potential of the photosensitive drum 10 is less than when the photosensitive drum 10 is charged to perform printing. To this end, an absolute value of the second charge bias voltage V_{D2} is set to be less than that of a first change bias voltage V_{C1}. In the current embodiment, the second charge bias voltage V_{C2} is set to about −900 V, and the surface potential of the photosensitive drum 10 is about −150 V in this case.

[Second Developing Bias Voltage V_{D2}]

A second developing bias voltage V_{D2} is applied to the developing roller 40. The second developing bias voltage V_{D2} is set to form an electric field that attracts the normal-polarity toner on the photosensitive drum 10 to the developing roller 40. For example, since the normal-polarity toner is charged to (−) polarity, the second developing bias voltage V_{D2} may be set such that a surface potential of the developing roller 40 is higher than that of the photosensitive drum 10. If the one-component developing method is employed, the difference between the surface potentials of the developing roller 40 and the photosensitive drum 10 may be increased as high as possible to improve a rate of collecting toner.

If the two-component developing method is employed, a carrier may move from the developing roller 40 to the photosensitive drum 10 and be then attached to the photosensitive drum 10 when the difference between the surface potentials of the developing roller 40 and the photosensitive drum 10 is too high. When the carrier is attached to the photosensitive drum 10, a surface of the photosensitive drum 10 may be damaged. Thus, the second developing bias voltage V_{D2} may be set such that the difference between the surface potentials of the developing roller 40 and the photosensitive drum 10 when toner is collected is the same as when printing is performed. To this end, the difference between the first charge bias voltage V_{C1} and the first developing bias voltage V_{D1} and the difference between the second charge bias voltage V_{C2} and the second developing bias voltage V_{D2} are set to be the same. For example, if the first charge bias voltage V_{C1} is −1350V and the first developing bias voltage V_{D1} is −450V when printing is performed, the difference between the surface potentials of the developing roller 40 and the photosensitive drum 10 is 900 V. If the second charge bias voltage V_{C2} is −900 V when toner is collected, the second developing bias voltage V_{D2} may be set to about 0 V so that the difference between the surface potentials of the developing roller 40 and the photosensitive drum 10 may be maintained to be 900 V similar to when printing is performed. Thus, when the two-component developing method is employed, a carrier may be prevented from being attached to the photosensitive drum 10 while toner is collected. In FIG. 4, ‘Δt1’ denotes a time period needed for a surface of the photosensitive drum 10 charged by the charge roller 20 to reach a region in which the photosensitive drum 10 and the developing roller 40 face each other.

[Second Transfer Bias Voltage V_{T2}]

A second transfer bias voltage V_{T2} having the same polarity as the normal-polarity toner is applied to the transfer roller 50. The second transfer bias voltage V_{T2} prevents residual toner on the photosensitive drum 10 from being attached to the transfer roller 50. For example, the second transfer bias voltage V_{T2} may be set to about −1500 V. In FIG. 4, ‘Δt2’ denotes a time period needed for the surface of the photosensitive drum 10 charged by the charge roller 20 to reach a region in which the photosensitive drum 10 and the transfer roller 50 face each other.

[Second Cleaning Bias Voltage V_{CL2}]

The second cleaning bias voltage V_{CL2} having the same polarity as the normal-polarity toner is applied to the cleaning roller 70. The second cleaning bias voltage V_{CL2} causes the normal-polarity toner on the cleaning roller 70 to be moved and attached to the photosensitive drum 10. In FIG. 4, ‘Δt3’ denotes a time period needed for the surface of the photosensitive drum 10 charged by the charge roller 20 to reach a region in which the photosensitive drum 10 and the cleaning roller 70 face each other.

[Auxiliary Charge Bias Voltage V_{ACL}]

An auxiliary charge bias voltage V_{ACL} that is the same as when printing is performed is applied to the auxiliary charge roller 80. The auxiliary charge bias voltage V_{ACL} may be about −850 V. Since the auxiliary charge bias voltage V_{ACL} has the same polarity as the normal-polarity toner, the normal-polarity toner moved from the cleaning roller 70 to the photosensitive drum 10 is not attached to the auxiliary charge roller 80. As described above, the auxiliary charge roller 80 transforms reverse-polarity toner and non-charged toner particles into normal-polarity toner and causes the normal-polarity toner to be attached to the surface of the photosensitive drum 10.

[Collecting of Residual Toner]

After a time period Δt3, the second cleaning bias voltage V_{CL2} causes the normal-polarity toner on the cleaning roller 70 to be moved and attached to a surface of the photosensitive drum 10 charged by the second charge bias voltage V_{C2}. When the photosensitive drum 10 rotates, the normal-polarity toner passes through regions in which the photosensitive drum 10 faces the auxiliary charge roller 80 and the charge roller 20 and is then delivered to a region in which the photosensitive drum 10 faces the developing roller 40. Since the auxiliary charge bias voltage V_{ACL} and the second charge bias voltage V_{C2} each having the same polarity as the normal-polarity toner are applied to the auxiliary charge roller 80 and the charge roller 20, respectively, the normal-polarity toner is not attached to the auxiliary charge roller 80 and the charge roller 20. As described above, the auxiliary charge roller 80 causes reverse-polarity toner and non-charged toner particles to be transformed into normal-polarity toner and attached to a surface of the photosensitive drum 10. In the region in which the photosensitive drum 10 faces the developing roller 40, the normal-polarity toner is separated from the photosensitive drum 10 due to the difference between surface potentials of the developing roller 40 and the photosensitive drum 10 formed by the second developing bias voltage V_{D2}, attached to the developing roller 40, and then collected in the developing unit 100.

Δt4 denotes a time period needed for the normal-polarity toner, which is delivered from the cleaning roller 70 to the photosensitive drum 10, to arrive at the region in which the photosensitive drum 10 faces the developing roller 40. Then, for a time period Δt5 (collecting time), the normal-polarity toner is collected on the developing roller 40. A printing speed, a warm-up time, etc. may be shortened by decreasing the collecting time Δt5.

The collecting time Δt5 may be expressed as an N-cycle time. If a one-cycle time of the cleaning roller 70 is T_{CL} and a one-cycle time of the photosensitive drum 10 is T_{PD}, the N-cycle time may be expressed by:

Δt5=N-cycle time=T_{CL}+(N−1)×T_{PD}

If N=1, it indicates that while the cleaning roller 70 rotates once, the normal-polarity toner on the cleaning roller 70 is entirely moved to the photosensitive drum 10 and is collected by the developing roller 40. In this case, Δt5=T_{CL}. For example, if N=2, it indicates that while the photosensitive drum 10 rotates once again after the cleaning roller 70 rotates once, the normal-polarity toner on the cleaning roller 70 is entirely moved to the photosensitive drum 10 and collected on the developing roller 40. In this case, Δt5=T_{CL}+T_{PD}. Similarly, if N=3, Δt5=T_{CL}+2×T_{PD}.

In order to decrease the collecting time Δt5, the difference between the surface potentials of the developing roller 40 and the photosensitive drum 10 may be increased. However, as described above, in the two-component developing method, increasing the difference between the surface potentials of the developing roller 40 and the photosensitive drum 10 is limited since a carrier is attached to the photosensitive drum 10. In the current embodiment, a contact region between the developing roller 40 and the photosensitive drum 10 is increased. To this end, a linear velocity of the developing roller 40 may be more increased when toner is collected than when printing is performed. A surface of the photosensitive drum 10 and a surface of the developing roller 40 move in a region in which they face each other, in the same direction. A linear velocity of the photosensitive drum 10 when toner is collected may be the same as when printing is performed. Also, the ratio of the linear velocity of the developing roller 40 to the linear velocity of the photosensitive drum 10 (linear velocity ratio) when toner is collected is set to be greater than when printing is performed. In this case, an area of the developing roller 40 that faces the photosensitive drum 10 increases for a same time period and residual toner may be thus rapidly collected on the developing roller 40.

Table 1 below shows a result of measuring the collecting time Δt5 while changing the linear velocity ratio. In table 1, ‘beginning of life’ refers to a point of time right after the toner cartridge 200 is substituted for a depleted toner cartridge, and ‘end of life’ refers to a point of time that the toner in the toner cartridge 200 is almost depleted. The conditions of the measurement are as follows:

first charge bias voltage V_{C1}: −1350V

second charge bias voltage V_{C2}: −900V

first developing bias voltage V_{D1}: −450V

second developing bias voltage V_{D2}: 0V

first transfer bias voltage V_{T1}: 500V

second transfer bias voltage V_{T2}: −1500V

first cleaning bias voltage V_{CL1}: 750V

second cleaning bias voltage V_{CL2}: −1000V

auxiliary charge bias voltage V_{ACL}: −600 to −1000V

diameter of photosensitive drum 10: 30 mm

diameter of cleaning roller 70: 12 mm

linear velocity of photosensitive drum 10: 90.92 mm/s

linear velocity ratio (in printing): 160%

TABLE 1

| | Linear velocity ratio (%) | | | | | | | |
|---|---|---|---|---|---|---|---|---|
| | 100 | 120 | 140 | 160 | 180 | 200 | 220 | 240 |
| Δt5(N) | 2 | 2 | 2 | 2 | 1 | 1 | 1 | 1 |
| (beginning of | | | | | | | | |
| life) | | | | | | | | |
| Δt5(N) | 3 | 3 | 3 | 2 | 2 | 1 | 1 | 1 |
| (end of life) | | | | | | | | |

(N = 1:Δt5 = 415 ms, N = 2:Δt5 = 1451 ms, N = 3:Δt5 = 2488 ms)

Referring to Table 1, if the linear velocity ratio when toner is collected is set to be greater by about 25% or more than when printing is performed, the collecting time Δt5 at the beginning and end of life=N=1. Thus, toner may be rapidly collected. The linear velocity ratio when toner is collected is limited by design factors such as the size of the image forming apparatus, the diameters of the photosensitive drum 10 and the developing roller 40, etc. Thus, the linear velocity ratio cannot be infinitely increased and is generally twice or less than when printing is performed.

Table 2 below shows a result of testing whether a ghost image error occurs or whether a background portion of an image is polluted while changing the second cleaning bias voltage V_{CL2} after printing is performed on about 5000 sheets of paper. The conditions of the test are as follows:
first charge bias voltage V_{C1}: −1350V
second charge bias voltage V_{D2}: −900V
first developing bias voltage V_{D1}: −450V
second developing bias voltage V_{D2}: 0V
first transfer bias voltage V_{T1}: 500V
second transfer bias voltage V_{T2}: −1500V
first cleaning bias voltage V_{CL1}: 750V
auxiliary charge bias voltage V_{ACL}: −600 to −1000V
linear velocity ratio (in printing): 160%
linear velocity ratio (in collecting): 200 to 240%

TABLE 2

| | Second cleaning bias voltage V_{CL2} | | | | | | | |
|---|---|---|---|---|---|---|---|---|
| | −1000 | −800 | −600 | −400 | −200 | 0 | 200 | 400 |
| Ghost image | OK | OK | OK | MA | MA | NG | NG | NG |
| error | | | | | | | | |
| Pollution of | OK | OK | MA | MA | NG | NG | NG | NG |
| background | | | | | | | | |
| portion | | | | | | | | |

(MA: marginally acceptable, NG: no good)

Referring to Table 2, an image error occurs when the second cleaning bias voltage V_{CL2} has polarity opposite to that of the normal-polarity toner, and the greater an absolute value of the second cleaning bias voltage V_{CL2}, the less an image error when the second cleaning bias voltage V_{CL2} has the same polarity as the normal-polarity toner. Also, the absolute value of the second cleaning bias voltage V_{CL2} may be greater than that of the second charge bias voltage V_{C2}.

Table 3 below shows a result of testing the degree of pollution of an image while changing the auxiliary charge bias voltage V_{ACL} after printing is performed on about 5000 sheets of paper. The conditions of the test are as follows:
first charge bias voltage V_{C1}: −1350V
second charge bias voltage V_{D2}: −900V
first developing bias voltage V_{D1}: −450V
second developing bias voltage V_{D2}: 0V
first transfer bias voltage V_{T1}: 500V
second transfer bias voltage V_{T2}: −1500V
first cleaning bias voltage V_{CL1}: 750V
second cleaning bias voltage V_{CL2}: −1000V
linear velocity ratio (in printing): 160%
linear velocity ratio (in collecting): 200 to 240%

TABLE 3

| | Auxiliary charge bias voltage V_{ACL} | | | | | | | |
|---|---|---|---|---|---|---|---|---|
| | 0 | −200 | −400 | −600 | −800 | −1000 | −1200 | −1400 |
| Ghost | NG | NG | MA | OK | OK | OK | MA | NG |
| image | | | | | | | | |
| error | | | | | | | | |

(MA: marginally acceptable, NG: no good)

Referring to Table 3, the greater the absolute value of the auxiliary charge bias voltage V_{ACL}, the lower the degree of pollution of the image. However, when the absolute value of the auxiliary charge bias voltage V_{ACL} is extremely high, the pollution of the image occurs. This is because when the absolute value of the auxiliary charge bias voltage V_{ACL} is extremely high, reverse-polarity toner is overcharged to normal polarity and is thus not collected on the developing roller 40. Therefore, the absolute value of the auxiliary charge bias voltage V_{ACL} may be less than that of the first charge bias voltage V_{C1}.

It should be understood that the exemplary embodiments described herein should be considered in a descriptive sense only and not for purposes of limitation. Descriptions of features or aspects within each embodiment should typically be considered as available for other similar features or aspects in other embodiments.

While one or more embodiments have been described with reference to the figures, it will be understood by those of ordinary skill in the art that various changes in form and details may be made therein without departing from the spirit and scope of the present disclosure as defined by the following claims and their equivalents.

What is claimed is:

1. An electrophotographic image forming apparatus comprising:
a photoreceptor;
a charger to which a first charge bias voltage is applied to charge the photoreceptor to a uniform potential;
an exposure device to form an electrostatic latent image by applying light, which is modulated according to image information, to the charged photoreceptor;
a developing roller to form a visual toner image by supplying toner onto the electrostatic latent image;
a transfer unit to which a first transfer bias voltage is applied to transfer the visual toner image onto a recording medium; and
a cleaning member to which a first cleaning bias voltage is applied to separate residual toner, which remains on the photoreceptor after the transfer of the visual toner image, from the photoreceptor when printing is performed and store the residual toner, and to which a second cleaning bias voltage is applied to attach the residual toner to the photoreceptor when the toner is collected,
wherein a first developing bias voltage is applied to the developing roller to supply the toner onto the electrostatic latent image when printing is performed,
wherein a second developing bias voltage is applied to the developing roller to collect the residual toner attached to the photoreceptor on the developing roller when the toner is collected, and
wherein when a ratio of a linear velocity of the developing roller to a linear velocity of the photoreceptor is a linear velocity ratio, the linear velocity ratio when the toner is collected is greater by about 25% or more than when printing is performed.

2. The electrophotographic image forming apparatus of claim 1, wherein the first cleaning bias voltage has the same polarity as the first transfer bias voltage, and wherein the first cleaning bias voltage has an absolute value that is greater than an absolute value of the first transfer bias voltage.

3. The electrophotographic image forming apparatus of claim 1, wherein a second transfer bias voltage having the same polarity as charge polarity of the residual toner is applied to the transfer unit when the toner is collected.

4. The electrophotographic image forming apparatus of claim 1, wherein a second charge bias voltage, having the same polarity as the first charge bias voltage and having an absolute value that is less than an absolute value of the first charge bias voltage, is applied to the charger, when the toner is collected.

5. The electrophotographic image forming apparatus of claim 4, wherein the second cleaning bias voltage has the same polarity as the second charge bias voltage and the second cleaning bias voltage has an absolute value that is greater than an absolute value of the second charge bias voltage.

6. The electrophotographic image forming apparatus of claim 4, wherein the difference between surface potentials of the developing roller and the photoreceptor when printing is performed is the same as when the toner is collected.

7. The electrophotographic image forming apparatus of claim 6, wherein the difference between the first charge bias voltage and the first developing bias voltage is the same as the difference between the second charge bias voltage and the second developing bias voltage.

8. The electrophotographic image forming apparatus of claim 1, wherein the second developing bias voltage is zero volts (0 V) when the toner is collected.

9. The electrophotographic image forming apparatus of claim 1, further comprising an auxiliary charge member which is disposed between the cleaning member and the charger and to which an auxiliary charge bias voltage is applied to charge reverse-polarity toner attached to the photoreceptor into normal-polarity toner.

10. The electrophotographic image forming apparatus of claim 9, wherein the auxiliary charge bias voltage when printing is performed is the same as when the toner is collected.

11. The electrophotographic image forming apparatus of claim 9, wherein the auxiliary charge bias voltage has an absolute value that is less than an absolute value of the first charge bias voltage.

12. The electrophotographic image forming apparatus of claim 1, wherein a linear velocity of the photoreceptor when printing is performed is the same as when the toner is collected.

13. An electrophotographic image forming apparatus comprising:
a photoreceptor on which an electrostatic latent image is formed;
a developing roller to form a visual toner image by supplying toner onto the electrostatic latent image;
a transfer unit to transfer the visual toner image onto a recording medium; and
a cleaning member to remove residual toner, which remains on the photoreceptor after the transfer of the visual toner image, from the photoreceptor,
wherein the image forming apparatus operates in a printing mode, and a collecting mode in which the residual toner on the cleaning member is collected on the developing roller via the photoreceptor, and
wherein a linear velocity of the developing roller in the collecting mode is faster than in the printing mode.

14. The electrophotographic image forming apparatus of claim 13, wherein a linear velocity of the photoreceptor in the collecting mode is the same as in the printing mode.

15. The electrophotographic image forming apparatus of claim 14, wherein, when a ratio of the linear velocity of the developing roller to the linear velocity of the photoreceptor is a linear velocity ratio, the linear velocity ratio in the collecting mode is greater by about 25% or more than in the printing mode.

16. The electrophotographic image forming apparatus of claim 13, further comprising:
a charger to charge the photoreceptor; and
an exposure device to form the electrostatic latent image by applying light, which is modulated according to image information, to the charged photoreceptor,
wherein, in the printing mode, a first cleaning bias voltage is applied to the cleaning member so as to separate the residual toner, which remains on the photoreceptor after the transfer of the visual toner image, from the photoreceptor and store the residual toner, and a first developing bias voltage is applied to the developing roller to supply the toner onto the electrostatic latent image, and
wherein, in the collecting mode, a second cleaning bias voltage is applied to the cleaning member to attach the residual toner thereon to the photoreceptor, a second developing bias voltage is applied to the developing roller to collect the residual toner attached to the photoreceptor on the developing roller, and a second charge bias voltage having an absolute value that is less than an absolute value of the first charge bias voltage in the printing mode is applied to the charger.

17. The electrophotographic image forming apparatus of claim 16, wherein:
a first transfer bias voltage having polarity opposite to charge polarity of the toner is applied to the transfer unit in the printing mode,
a second transfer bias voltage having the same polarity as the charge polarity of the toner is applied to the transfer unit in the collecting mode, and
the first cleaning bias voltage has the same polarity as the first transfer bias voltage and the first cleaning bias voltage has an absolute value that is greater than the first transfer bias voltage.

18. The electrophotographic image forming apparatus of claim 17, wherein the second cleaning bias voltage has the same polarity as the second charge bias voltage and the second cleaning bias voltage has an absolute value that is greater than an absolute value of the second charge bias voltage.

19. The electrophotographic image forming apparatus of claim 18, further comprising an auxiliary charge member which is disposed between the cleaning member and the charger, and to which an auxiliary charge bias voltage is applied to charge reverse-polarity toner attached to the photoreceptor to normal polarity,
wherein the auxiliary charge bias voltage has an absolute value that is less than an absolute value of the first charge bias voltage.

20. The electrophotographic image forming apparatus of claim 16, wherein the second developing bias voltage is zero volts (0 V) in the collecting mode.
